(19) United States
(12) Patent Application Publication
(10) Pub. No.: US 2010/0102957 A1
(43) Pub. Date: Apr. 29, 2010

(54) Monitoring Device With Network Connection and Security Component

(75) Inventor: Mark Rutledge, Murrieta, CA (US)

Correspondence Address: FISH & ASSOCIATES, PC;ROBERT D. FISH, 2603 Main Street, Suite 1000, Irvine, CA, 92614-6232, US

(73) Assignee: DEI HOLDINGS, INC., Vista, CA (US)

(21) Appl. No.: 12/260,310

(22) Filed: Oct. 29, 2008

(51) Int. Cl. G08B 1/08; H04M 11/04

(52) U.S. Cl. 340/539.14; 340/539.25; 455/404.1

(57) ABSTRACT

A monitoring device has a smoke detector, a network connection and a security component. The security component could include a camera, a microphone, a motion detector, and an audio output component. The monitoring device could have a wireless access point and connect to a network using IP over power line. Preferably, the monitoring device can use an existing power line. The monitoring device could communicate information with a recipient.

### FIELD OF THE INVENTION

The field of the invention is a monitoring device for a home or business.

### BACKGROUND

Smoke detectors are now ubiquitous in homes and offices. They are typically battery and/or line powered devices, and have a siren to alert any occupants of a potential fire. While the sound produced by the siren is often life-saving, simple smoke detectors usually have no facility for notifying emergency responders of an emergency. Thus, an occupant must generally telephone an emergency responder before any help will arrive.

It is known for smoke detectors to be coupled to a security system within a building, and for the security system to provide alerts to an emergency responder using a data network. One problem with that configuration is that it can be quite expensive to couple the smoke detectors to the security system, especially when retrofitting an existing building. One could use a wireless connection between detectors and the security system, but wireless networks are not always practical, or reliable. For example, wireless networks can succumb to interference, including electronics operating on a similar frequency and metal support structures within a building.

In addition to smoke detectors, security systems often have other security components including for example cameras, microphones, motion detectors, door and window opening detectors, and each of those can also have connectivity issues. Those additional components can be hard-wired to the security system, which is costly, or connected to the system over a wireless connection which can be unreliable. The problem of high installation cost is especially significant where the security components are spread throughout the building.

One solution has been to combine multiple security components together. For example, US patent application no. 2008/0122929 to Chukwu (publ May 29, 2008) is known to include a camera and microphone within a smoke detector. In such combined security components, the connectivity for one component can be piggy-backed onto the connectivity of the other components. That saves money during installation, but still requires additional wiring or a wireless infrastructure.

Chukwu and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a monitoring device, and especially a monitoring device having multiple functionalities, that avoids the need for additional wiring or a wireless infrastructure.

### SUMMARY OF THE INVENTION

In one aspect, the inventive subject matter provides apparatus, systems and methods in which a monitoring device is coupled to a security system using IP over power line.

In preferred embodiments, multiple security components can be combined within a smoke detector or other housing to form a monitoring device. Components that can advantageously be combined include a camera, a microphone, a motion detector, and an audio output component. Especially preferred embodiments include three, four or more such components within a single housing. Unless a contrary intent is apparent from the context, all ranges recited herein are inclusive of their endpoints, and open-ended ranges should be interpreted to include only commercially practical values.

Not only can different security components be combined, but it is especially contemplated that a given component can serve multiple functions. For example, whatever audio output is used to produce a siren or other alarm sound can also be used to produce understandable speech.

In another aspect, use of an audio output to produce both alarm sounds and speech can be advantageously combined with a wireless access point, with or without IP over power line functionality.

The security system can communicate information received from a monitoring device to the outside world in any suitable manner. Examples include a hard-wired link, a wireless link, and a telephone or data link. Contemplated recipients include police, a security system command center, and a designated monitoring station. It is especially contemplated that the information (images, sound, etc) could be displayed on any suitable medium, including for example a cellular telephone.

The monitoring device can be installed as original equipment, or can be installed to retrofit original equipment. Thus, for example, a monitoring device that includes a smoke detector, a camera and a microphone can be used to replace an existing smoke detector. Where connectivity is provided by IP over power line, either original installation or retrofit could be accomplished without any additional wiring.

Where a monitoring device includes wireless connectivity, the monitoring device could operate as a wireless access point. In a house, for example, smoke detectors are often installed in every room, and every hallway. Inclusion of wireless access points in the same housings as the smoke detectors would provide immediate, inexpensive, and extremely strong signals throughout the house. The wireless access points could advantageously connect to the network using the IP over power line protocol.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is an enlarged illustration of an embodiment of a monitoring device.

FIGS. 2a-2b are illustrations of alternate embodiments of the monitoring device in FIG. 1.

FIG. 3 is an illustration of an embodiment of a smoke detector coupled to a security system.

### DETAILED DESCRIPTION

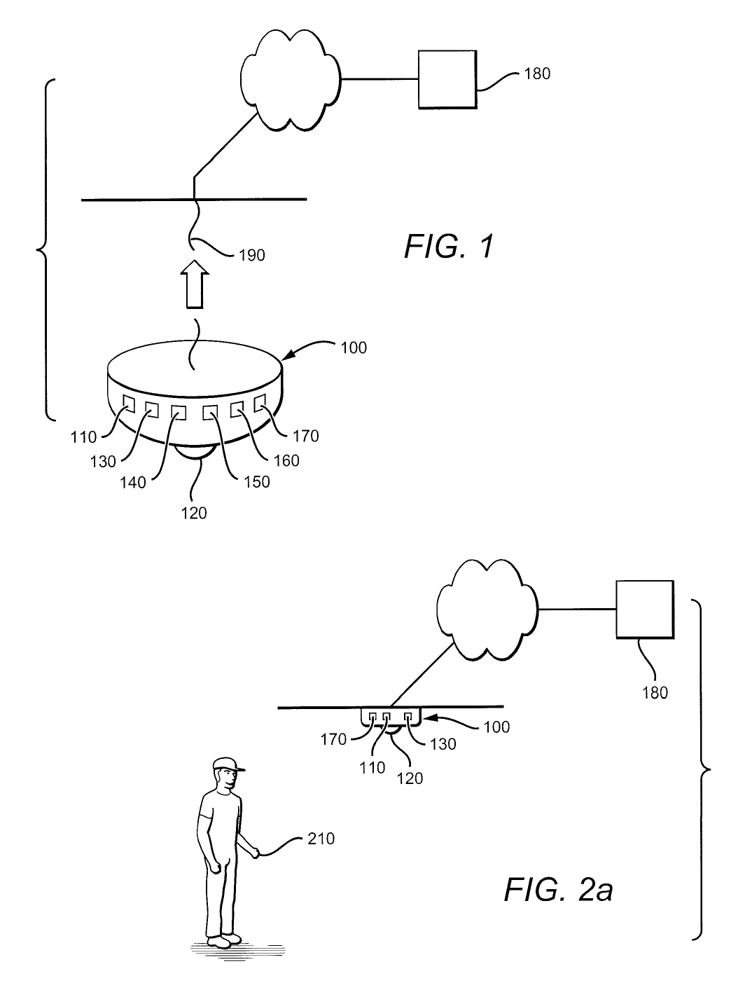

In FIG. 1 a monitoring device 100 generally includes a smoke detector 110, an IP over power line adapter 170, a wireless access point 160, and a security component that can include a camera 120, a microphone 130, a motion detector 140, and an audio output component 150.

The IP over power line adapter 170 generally enables the monitoring device 100 to connect to a network. The adapter 170 allows information to be communicated from the monitoring device 100 to a recipient 180 over the power line. For example, using the adapter 170, information can be communicated from the monitoring device 100 to a security system (not shown) over the power line. Preferably, adapter 170 connects to an existing power line 190 to allow information to be communicated without the need for additional wiring. In other contemplated embodiments, monitoring device 100 can communicate information using a wireless or wired connection, including a hard-wired link, a wireless link, and a telephone or data link. In another embodiment, monitoring device 100 can include a wireless network card (not shown) to communicate information over an existing wireless network.

Smoke detector 110 is used to detect smoke and sound an alarm to aleit of the presence of fire in an area. The smoke detector 110 can detect the presence of smoke in the air utilizing optics. In other contemplated embodiments, smoke detector 100 can detect the presence of smoke utilizing ionization or air sampling. Preferably, smoke detector 110 can utilizing at least two of optics, ionization or air sampling for increased sensitivity in detecting smoke. It is contemplated that any sensor that can detect smoke or a fire can comprise smoke detector 110. In FIG. 1, smoke detector 110 can communicate to recipient 180 using IP over power line adapter 170.

In FIG. 1, the monitoring device 100 includes a camera 120, a microphone 130, a motion detector 140, and an audio output component 150. In other embodiments, monitoring device 100 could include any combination of a camera, a microphone, a motion detector, an audio output component, a CO2 detector, a door or window opening detector, etc.

Preferably, camera 120 is an IP camera to allow images or video to be communicated to a recipient 180. In other contemplated embodiments, camera 120 can include a digital camera, a webcam, and a video camera. Preferably, camera 120 can capture still frames as well as video. By including camera 120 within the monitoring device 100, a picture of an area can be recorded. With an IP camera, the recording can be communicated to a recipient 180, allowing recipient 180 to view the recording and determine what is occurring. For example, a parent could utilize the recording from the IP camera to see that the children are doing well. In another example, an owner of a building can examine the recoding to determine if a burglar is inside of the building. In another embodiment, the recording from the camera 120 can be stored for later viewing.

Microphone 130 preferably is coupled to camera 120 and operable over the network. In one embodiment, microphone 130 is an omnidirectional microphone, allowing microphone to detect noise in all directions. In other contemplated embodiments, a unidirectional or other directionality could be used. The inclusion of microphone 130 within the monitoring device 100 allows sound to be detected. In one aspect, sound detected by the microphone 130 can be communicated to recipient 180. In this aspect, recipient 180 can hear any sound within an area. When advantageously coupled with camera 120, sound and images from the area can be detected and communicated to a recipient. Thus, recipient 180 can have a clearer understanding of what is occurring in the area.

Motion detector 140 preferably is an infrared sensor to detect motion within an area. If motion is detected, an alarm is typically sounded. In other contemplated embodiments, motion detector 140 could include an ultrasonic or microwave sensor. It is preferred that a combination of these sensors is used to increase accuracy of the detector 140.

In a preferred embodiment, audio output component 150 is a speaker that can produce an alarm sound as well as understandable speech. In other contemplated embodiments, audio output component 150 can include an alarm, a buzzer, a speaker, a siren, and a bell. In a preferred aspect, audio output component 150 is operable through the network connection. In this aspect, a recipient 180 can communicate with an occupant of a building (not shown) using the speaker. For example, if motion detector 140 detects an intruder in a building, the motion detector triggers camera 120 and microphone 130 to record. Information from motion detector 140, camera 120, and microphone 130 can be communicated with recipient 180 who can communicate with the intruder via the speaker 150 while providing information to the police.

Wireless access point 160 preferably is coupled with the IP over power line adapter 170. In this aspect, wireless access point 160 can be used to create a wireless network. In another contemplated embodiment, wireless access point 160 could bridge an existing wireless network. In either embodiment, access to the wireless network can be provided in every area where monitoring device 100 is installed.

Preferably, monitoring device 100 can use an existing power line 190 for power. In other contemplated embodiment, a battery can be provided as an alternative or additional power source.

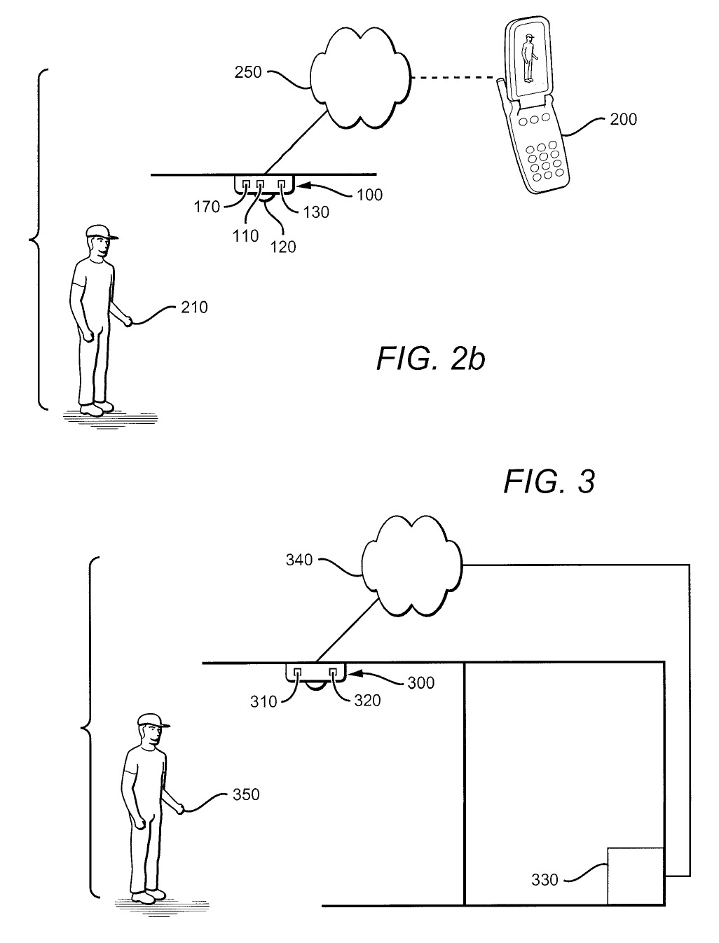

FIG. 2a is an alternate embodiment of the monitoring device 100 in FIG. 1. Monitoring device 100 includes an IP over power line adapter 170, as well as a smoke detector 110, a camera 120, and a microphone 130, all of which can utilize the IP over power line adapter 170 to communicate information 210 to a recipient (not shown). In a preferred embodiment, the information 210 can include video from the camera 120 and audio from the microphone 130. In one example, shown in FIG. 2b, the information is communicated over a network 250 to a cellular telephone 200 of a natural person (not shown). In this example, using the cellular telephone 200, the natural person can view and hear an intruder. This is advantageous as it can help eliminate false alarms and provide more accurate information to police.

In other contemplated embodiments, recipient can include a natural person, police, a security system command center, and a designated monitoring station.

In FIG. 3, a smoke detector 300 generally comprises a network connection 310 and an audio output component 320.

The network connection 310 preferably is an IP over power line adapter, as described above. In other contemplated embodiments, the network connection 310 can include a hard-wired link, a wireless link, and a telephone or data link.

In a preferred embodiment, audio output component 320 is coupled to the smoke detector 300 and operable through the network connection 310. Audio output component can preferably communicate with a security system 330 over the network 340. In this aspect, security system can sound audio output component 320 when an event 350 occurs. An event 350 can be any triggering of the monitoring device 300 including for example a fire, smoke, a burglar, and a flood.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A monitoring device, comprising:
a smoke detector;
a network connection provided by a wireless access point and IP over power line; and
a security component operable through the network connection, and selected from the list consisting of a camera, a microphone, a motion detector, and an audio output component.

2. The monitoring device of claim 1, wherein the security component comprises the camera.

3. The monitoring device of claim 1, wherein the security component comprises the microphone.

4. The monitoring device of claim 1, wherein the security component comprises the motion detector.

5. The monitoring device of claim 1, wherein the security component comprises the audio output component operable through the network connection.

6. The monitoring device of claim 5, wherein the audio output component comprises a speaker that can produce understandable speech.

7. The monitoring device of claim 1, further comprising a second security component operable through the network connection, and selected from the list.

8. The monitoring device of claim 7, further comprising a third security component operable through the network connection, and selected from the list.

9. The monitoring device of claim 8, further comprising a fourth security component operable through the network connection, and selected from the list.

10. A method of providing a security information to a natural person, comprising securing a video feed from the monitoring device of claim 1, and communicating the video feed to a person via a cellular telephone.

11. The monitoring device of claim 1, wherein the monitoring device is connected to a security system.

12. A smoke detector that communicates with a security system, comprising:
a network connection provided by at least one of a wireless access point and an IP over power line; and
an audio output component functionally connected to the security system through the network connection, wherein the security system operates the audio output component.

13. The smoke detector of claim 12 further comprising a security component operable through the network connection, and selected from the list consisting of a camera, a microphone, a motion detector, and an audio output component.
